(19) United States
(12) Patent Application Publication
(10) Pub. No.: US 2003/0177852 A1
(43) Pub. Date: Sep. 25, 2003

(54) Apparatus for absorbing impact of starter

(76) Inventors: Young-Il Kim, Kyongju-si (KR); Duck-Geun Yoo, Kyongju-si (KR)

Correspondence Address: R. Neil Sudol, COLEMAN SUDOL SAPONE, P.C., 714 Colorado Avenue, Bridgeport, CT, 06605-1601, US

(21) Appl. No.: 10/105,005

(22) Filed: Mar. 22, 2002

(51) Int. Cl. F02N 11/00

(52) U.S. Cl. 74/6; 74/7 E

(57) ABSTRACT

The present invention relates to an apparatus for absorbing an impact of a starter, and in particular to an apparatus for absorbing impact of a starter which is capable of is capable of concurrently absorbing an impact in an axial direction and an impact in a rotational direction which are generated when driving a starter at an initial stage, enhancing an operational efficiency of a starter based on an impact absorption in the axial direction and rotational direction and preventing a crack or damage of a planetary gear which rotates a ring gear of an engine in a starter. In the apparatus for absorbing an impact of a starter, a center bracket is installed in a center portion of a housing in which an armature is installed, for thereby supporting a shaft of the armature, a planetary gear which is tooth-engaged with a gear installed in a shaft of the armature is installed in one side of the center bracket and is supported by a support, an internal gear is installed in an outer circumferential portion of the planetary gear, a steel ball is installed in the center portion of the support in such a manner that a front end of the shaft of the armature is supported, a front bracket which is connected with the housing and supports the internal gear is installed in one side of the support, and a damper is installed between the center bracket and the internal gear assembly in which the internal gear is installed, for thereby surrounding the outer circumferential portion of the assembly and concurrently absorbing the torsion impact and the impact in the axial direction.

### BACKGROUND OF THE INVENTION

1. Field of the Invention

The present invention relates to an apparatus for absorbing an impact of a starter, and in particular to an apparatus for absorbing impact of a starter which is capable of is capable of concurrently absorbing an impact in an axial direction and an impact in a rotational direction which are generated when driving a starter at an initial stage, enhancing an operational efficiency of a starter based on an impact absorption in the axial direction and rotational direction and preventing a crack or damage of a planetary gear which rotates a ring gear of an engine in a starter.

2. Description of the Background Art

Generally, in a start engine installed for driving an engine of a vehicle, as an armature rotates a gear and a pinion gear, an armature and field unit are installed in a housing for driving an engine. The armature is rotated based on a magnetic operation thereof for thereby rotating a planetary gear and an internal gear and driving a pinion gear based on a rotary shaft connected thereto. The pinion gear rotates a ring gear installed in a side of an output shaft of an engine of a vehicle for thereby driving an engine.

As shown in FIG. 1, a center bracket 401 which supports a shaft 301 of an armature 201 is installed in a center portion of a housing 101 in which an armature 201 is installed. A planetary gear 601 tooth-engaged with a gear 501 installed in a shaft 301 of the armature is installed and supported by a support 701. An internal gear 801 is installed in an outer circumferential portion of the planetary gear 601. A steel ball 901 is installed in the center portion of the support 701 in such a manner that a front end of the shaft 301 of the armature is supported. A front bracket 110 which is connected with the housing 101 and supports the internal gear 801 is installed in one side of the support 701. A washer 111 is installed between the support 701 and the front internal gear 801. A packing 112 is installed between the outer circumferential portions of the center bracket 401, the front bracket 110 and the internal gear 801.

In the above conventional construction, when the armature 201 installed in the housing 101 is rotated, the rotational force is transferred to the internal gear 801 through the gear 501 and the planetary gear 601. The transferred rotational force is applied to the pinion of the starter. In a state that the pinion is engaged with the ring gear of the engine, the engine is driven.

When driving the start at an initial stage, in a state that the planetary gear and the internal gear are stopped, since the armature is rotated suddenly, a high weight and strong impact are applied to the planetary gear and the internal gear, so that only the packing receive the above high weight and strong impact. Therefore, in the conventional art, it is impossible to fully absorb the weight and impact.

Since the packing is capable of receiving only an axial direction impact, it is impossible to receive the weight and impact in the rotational direction based on the rotation of the armature. Therefore, the planetary gear and the internal gear may be easily broken or damaged by the rotational weight and impact. In addition, the rotational force of the starter is not efficiently transferred to the engine, so that the engine does not efficiently operate.

### SUMMARY OF THE INVENTION

Accordingly, it is an object of the present invention to provide an apparatus for absorbing an impact of a starter which overcomes the problems encountered in the conventional art.

It is another object of the present invention to provide an apparatus for absorbing an impact of a starter which is capable of concurrently absorbing an impact in an axial direction and an impact in a rotational direction which are generated when driving a starter at an initial stage, enhancing an operational efficiency of a starter based on an impact absorption in the axial direction and rotational direction and preventing a crack or damage of a planetary gear which rotates a ring gear of an engine in a starter.

To achieve the above objects, there is provided an apparatus for absorbing an impact of a starter in which a center bracket is installed in a center portion of a housing in which an armature is installed, for thereby supporting a shaft of the armature, a planetary gear which is tooth-engaged with a gear installed in a shaft of the armature is installed in one side of the center bracket and is supported by a support, an internal gear is installed in an outer circumferential portion of the planetary gear, a steel ball is installed in the center portion of the support in such a manner that a front end of the shaft of the armature is supported, a front bracket which is connected with the housing and supports the internal gear is installed in one side of the support, and a damper is installed between the center bracket and the internal gear assembly in which the internal gear is installed, for thereby surrounding the outer circumferential portion of the assembly and concurrently absorbing the torsion impact and the impact in the axial direction.

### BRIEF DESCRIPTION OF THE DRAWINGS

The present invention will become better understood with reference to the accompanying drawings which are given only by way of illustration and thus are not limitative of the present invention, wherein:

FIG. 1 is a cross-sectional view illustrating the construction of a conventional apparatus for absorbing an impact of a starter;

FIG. 2 is a disassembled perspective view illustrating the construction of an apparatus for absorbing an impact of a starter according to the present invention;

FIG. 3 is a perspective view illustrating a damper adapted in an apparatus for absorbing an impact of a starter according to the present invention; and

FIG. 4 is a cross-sectional view illustrating an engaged state of an apparatus for absorbing an impact of a starter according to the present invention.

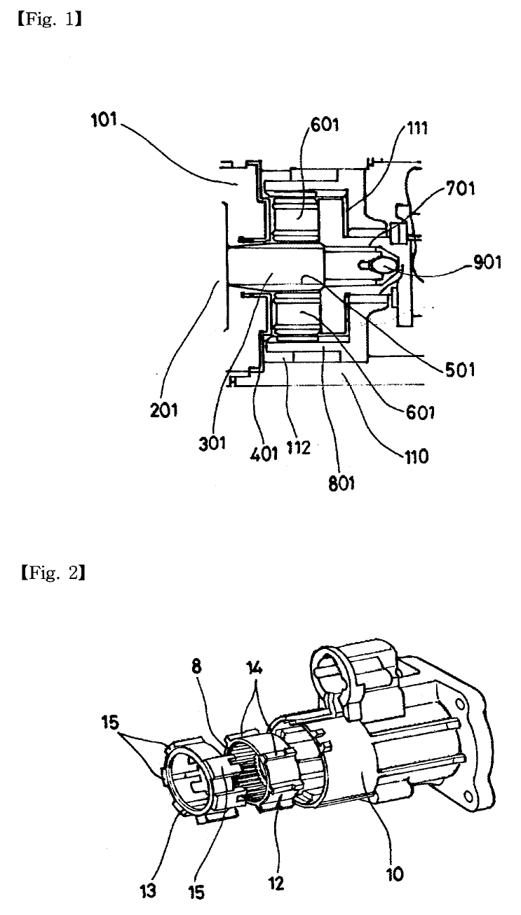

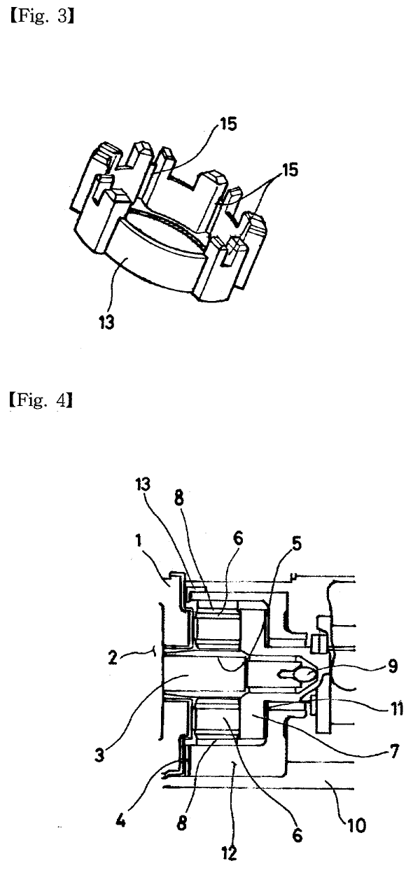

### DETAILED DESCRIPTION OF THE PREFERRED EMBODIMENTS

The preferred embodiments of the present invention will be described with reference to the accompanying drawings.

First, a center bracket 4 is installed in a center portion of a housing 1 in which an armature 2 is installed. A planetary gear 6 tooth-engaged with a gear 5 installed in a shaft 3 of the armature is installed in one side of the center bracket 4 and is supported by a support 7. An internal gear 8 is installed in an outer circumferential portion of the planetary gear 6. A steel ball 9 is installed in the center portion of the support 7 in such a manner that a front end of the shaft 3 of the armature us supported. A front bracket 10 which is connected with the housing 1 and supports the internal gear 8 is installed in one side of the support 7 using a washer 11 disposed therein. A damper 13 is installed between the center bracket 4 and an internal gear assembly 12 in which the front bracket 10 and the internal gear 8 are installed for thereby surrounding an outer circumferential portion of the internal gear assembly, so that the damper 13 concurrently receives a torsion impact and an impact in an axial direction.

In addition, the damper 13 includes an insertion portion 15 for being engaged with an outer circumferential portion of the internal gear assembly 12, and a protrusion shoulder portion 14 is formed in an outer circumferential portion of the internal gear assembly 12, so that the damper 13 is not moved.

In the above construction according to the present invention, when a power is applied, and the armature 2 installed in the housing 1 is rotated, the shaft 3 of the armature protruded in one side of the center bracket 4 and the gear 5 installed therein are rotated. As the gear 5 is rotated, the planetary gear 6 engaged thereto is supported by the support 7 and is rotated. The internal gear 8 engaged to the outer portion of the planetary gear 6 is rotated for thereby rotating the pinion. The pinion rotates the ring gear of the engine, so that the engine is driven.

As the starter operates, the front end of the shaft 3 of the armature is supported by the steel ball 9 installed in the support 7, so that it is possible to a smooth rotation without movement.

When the starter is driven at an initial stage, in a state that the planetary gear 6 and the internal gear 8 are stopped, the armature receives a certain weight suddenly, and receives an impact. When the weight and impact are transferred to the internal gear 8 through the planetary gear 6, the transferred impact is transferred to the damper 13 which surrounds the outer circumferential portion of the internal gear assembly 12, and the damper 13 absorbs the impacts in the torsion impact and the impact in the axial direction, so that the impact transferred to the planetary gear 6 and the internal gear 8 are absorbed.

An insertion portion 15 engaged with an outer circumferential portion of the internal gear assembly 12 is formed in one side of the damper 13, and a protrusion shoulder portion 14 is formed in an outer circumferential portion of the internal gear assembly 12 in a portion corresponding thereto, so that the damper 13 is not moved for thereby quickly receiving the weight and impact. Therefore, it is possible to prevent any damage of the gear 5, the planetary gear 6 and the internal gear 8.

As described above, in the present invention, the damper is installed between the internal gear assembly and the center bracket of the starter based on a simple construction, so that the damper absorbs a sudden impact and weight when the starter operates at an initial stage, whereby it is possible to prevent any damage and breakage of the planetary gear and the internal gear based on a sudden weight and impact using one part. In addition, since it is possible to stably and easily assemble the damper, the assembling operation of the starter is easily implemented. It is possible to significantly enhance the operation efficiency base don the absorption of the impact weight.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. An apparatus for absorbing an impact of a starter in which a center bracket is installed in a center portion of a housing in which an armature is installed, for thereby supporting a shaft of the armature, a planetary gear which is tooth-engaged with a gear installed in a shaft of the armature is installed in one side of the center bracket and is supported by a support, an internal gear is installed in an outer circumferential portion of the planetary gear, a steel ball is installed in the center portion of the support in such a manner that a front end of the shaft of the armature is supported, a front bracket which is connected with the housing and supports the internal gear is installed in one side of the support, and a damper is installed between the center bracket and the internal gear assembly in which the internal gear is installed, for thereby surrounding the outer circumferential portion of the assembly and concurrently absorbing the torsion impact and the impact in the axial direction.

2. The apparatus of claim 1, wherein in said damper 13, an insertion portion 15 engaged with an outer circumferential portion of the internal gear assembly 12 is formed in one side of the same, and a protrusion shoulder portion 14 is formed in an outer circumferential portion of the internal gear assembly 12 in a portion corresponding thereto, so that the damper 13 is not moved.

3. The apparatus of claim 1, wherein said damper is integrally formed for thereby effectively absorbing an impact.
